(19) United States
(12) Patent Application Publication
(10) Pub. No.: US 2015/0104158 A1
(43) Pub. Date: Apr. 16, 2015

(54) DIGITAL SIGNAL REPRODUCTION DEVICE

(71) Applicant: PANASONIC CORPORATION, Osaka (JP)

(72) Inventors: Hiroshi IKEDA, Osaka (JP); Shuji MIYASAKA, Osaka (JP)

(21) Appl. No.: 14/572,751

(22) Filed: Dec. 16, 2014

Related U.S. Application Data
(62) Division of application No. 13/281,002, filed on Oct. 25, 2011.
Application No. 13/281,002 is a continuation of application No. PCT/JP2010/002924, filed on Apr. 22, 2010.

(30) Foreign Application Priority Data
Apr. 28, 2009 (JP) 2009-109596

(51) Int. Cl. H04N 5/783; H04N 5/93; G10L 25/78

(52) U.S. Cl. CPC H04N 5/783; G10L 25/78; H04N 5/93
USPC 386/356; 704/500

(57) ABSTRACT

A digital signal reproduction device includes an audio decoder configured to decode an audio bit stream to output a resulting audio signal, an audio bit stream analyzer configured to analyze whether or not the audio bit stream contains human voice, a playback speed determiner configured to determine a playback speed based on a result of the analysis by the audio bit stream analyzer, and a variable speed reproducer configured to receive the audio signal and reproduce an audio signal corresponding to the playback speed determined by the playback speed determiner.

### CROSS-REFERENCE TO RELATED APPLICATIONS

This application is a Divisional of U.S. patent application Ser. No. 13/281,002, filed on Oct. 25, 2011 which is a continuation of PCT International Application PCT/JP2010/002924 filed on Apr. 22, 2010, which claims priority to Japanese Patent Application No. 2009-109596 filed on Apr. 28, 2009. The disclosures of these applications including the specifications, the drawings, and the claims are hereby incorporated by reference in their entirety.

### BACKGROUND

The technology disclosed herein relates to digital signal reproduction devices for playback of bit streams which are obtained by encoding audio signals containing human voice, and digital signal compression devices which generate bit streams from audio signals containing human voice.

Recorders which digitally compress television broadcast signals before recording the resulting data into a storage medium, such as a digital versatile disc (DVD), a Blu-ray Disc (BD), a hard disk drive (HDD), etc., have been developed. In particular, in recent years, the increase in the capacity of a storage medium has enabled recording of television broadcasts over a long time. Therefore, the quantity of recorded programs may become so huge that the user does not have sufficient time to view all the programs.

Therefore, there is a recorder which has a fast playback function to play a recorded program over a period of time shorter than that which it has taken to record the program. For example, if playback is performed at a speed 1.5 times as high as the normal speed, it takes only 40 minutes to play a one-hour program. However, in the case of such fast playback, it is difficult to hear and recognize words spoken by actors, announcers, etc.

To address this problem, there is a technique of performing playback at a speed which is not very high in sections which contain speech (human voice) spoken by actors, announcers, etc., and at a high speed in sections which do not contain speech. For example, Japanese Patent Publication No. 2003-309814 describes the following technique. Specifically, audio data is analyzed to determine and store a playback speed for each section. When an audio signal etc. is actually reproduced, the reproduction is performed based on the previously determined playback speed. International Publication WO2006/082787 describes a technique of reproducing an audio signal etc. based on a playback speed which is determined based on audio data, where the playback speed is not stored.

### SUMMARY

In the configurations of Japanese Patent Publication No. 2003-309814 and International Publication WO2006/082787, it is necessary to detect whether or not human voice is contained, based on a pulse code modulation (PCM) signal, which is a time-domain signal obtained by decoding a bit stream, resulting in a large amount of computation. This is because such detection requires determination of whether or not the PCM signal has a frequency characteristic similar to that of human voice, whether or not the PCM signal has a fundamental frequency (pitch frequency) matching that of human voice, etc., and therefore, it is necessary to perform signal processing which requires a large amount of computation, such as conversion to a frequency-domain signal, autocorrelation processing, etc.

The present disclosure describes implementations of a digital signal reproduction device for determining a section containing human voice with a smaller amount of computation. The present disclosure also describes implementations of a digital signal compression device for generating a bit stream for which it is easier to determine a section containing human voice.

An example digital signal reproduction device according to the present disclosure includes an audio decoder configured to decode an audio bit stream to output a resulting audio signal, an audio bit stream analyzer configured to analyze whether or not the audio bit stream contains human voice, a playback speed determiner configured to determine a playback speed based on a result of the analysis by the audio bit stream analyzer, and a variable speed reproducer configured to receive the audio signal and reproduce an audio signal corresponding to the playback speed determined by the playback speed determiner.

As a result, it is determined whether or not speech is contained, directly based on the audio bit stream before decoding, whereby the amount of computation required to determine whether or not speech is contained can be reduced.

An example digital signal compression device according to the present disclosure includes an audio signal classifier configured to analyze each section having a predetermined length of an audio signal, and determine an index indicating how much a human voice component is contained in the section of the audio signal, and an audio encoder configured to encode a section of the audio signal corresponding to the index based on a linear prediction coding scheme for the index larger than a predetermined threshold, or a frequency domain coding scheme for the index smaller than or equal to the predetermined threshold, and output resulting first encoded data.

As a result, the quality of encoding can be improved. Moreover, during a playback of the resulting encoded data, it can be easily determined whether or not speech is contained, only by analyzing the frequency at which the linear prediction coding scheme is used.

According to the present disclosure, in the example digital signal reproduction device, the amount of computation required to determine whether or not speech is contained in encoded data can be reduced. Also, during a playback of encoded data obtained in the example digital signal compression device, it can be easily determined whether or not speech is contained. Therefore, hearing of speech can be facilitated even during fast playback.

### BRIEF DESCRIPTION OF THE DRAWINGS

FIG. 1 is a block diagram showing an example configuration of a digital signal reproduction device according to a first embodiment of the present disclosure.

FIG. 2 is a block diagram showing an example configuration of a digital signal compression device according to the first embodiment of the present disclosure.

FIG. 3 is a block diagram showing a configuration of a first variation of the digital signal compression device of FIG. 2.

FIG. 4 is a block diagram showing a configuration of a second variation of the digital signal compression device of FIG. 2.

FIG. 5 is a block diagram showing an example recorder system including the digital signal reproduction device of FIG. 1 and the digital signal compression device of FIG. 2.

FIG. 6 is a block diagram showing an example configuration of a digital signal reproduction device according to a second embodiment of the present disclosure.

FIG. 7 is a block diagram showing a configuration of a variation of the digital signal reproduction device of FIG. 6.

FIG. 8 is a diagram showing typical example combinations of the type(s) and number of pictures to be skipped and a playback speed.

### DETAILED DESCRIPTION

Embodiments of the present disclosure will be described hereinafter with reference to the accompanying drawings. In the drawings, the same or similar parts are identified by the same reference numerals or by reference numerals having the same last two digits.

As used herein, the term “speech” refers to human voice, and the term “speech signal” refers to a signal mainly representing human voice. As used herein, the term “audio signal” refers to a signal which may represent any sounds, such as sounds produced by musical instruments, etc., in addition to human voice.

Functional blocks described herein may be typically implemented by hardware. For example, functional blocks may be formed as a part of an integrated circuit (IC) on a semiconductor substrate. Here, ICs include large-scale integrated (LSI) circuits, application-specific integrated circuits (ASICs), gate arrays, field programmable gate arrays (FPGAs), etc. Alternatively, all or a portion of functional blocks may be implemented by software. For example, such functional blocks may be implemented by a program being executed by a processor. In other words, functional blocks described herein may be implemented by hardware, software, or any combination thereof.

### First Embodiment

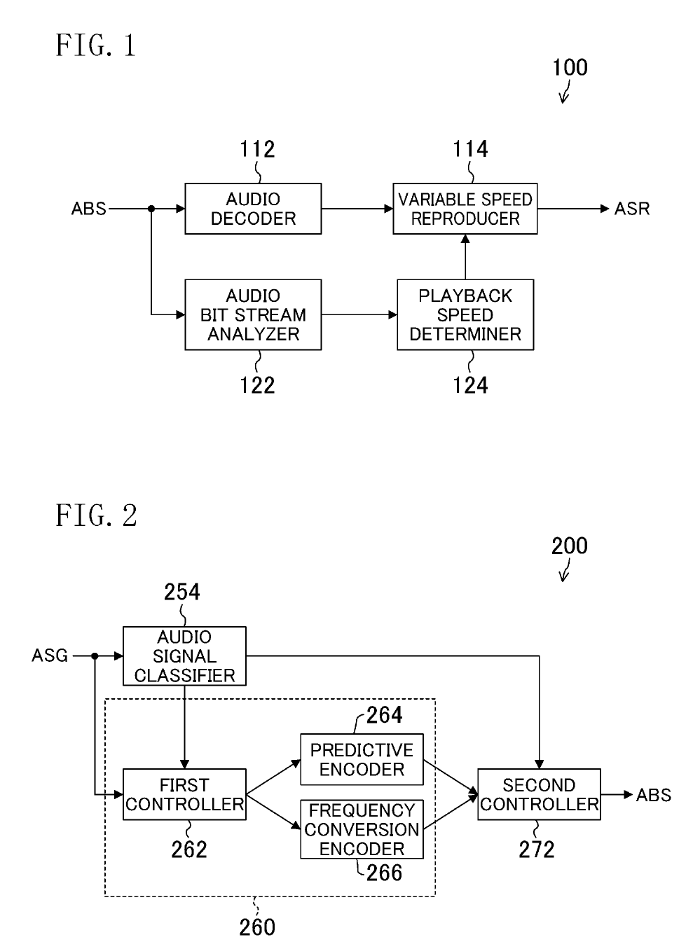

FIG. 1 is a block diagram showing an example configuration of a digital signal reproduction device according to a first embodiment of the present disclosure. The digital signal reproduction device 100 of FIG. 1 includes an audio decoder 112, a variable speed reproducer 114, an audio bit stream analyzer 122, and a playback speed determiner 124.

The audio decoder 112 and the audio bit stream analyzer 122 receive an audio bit stream ABS. For example, the audio bit stream ABS is assumed to be a bit stream which is encoded using the advanced audio coding (AAC) scheme defined in the moving picture experts group (MPEG) standards (ISO/IEC13818-7).

A process of generating an audio bit stream by encoding an input audio signal using the AAC scheme will be briefly described. When an audio bit stream is generated, an input audio signal which is a pulse code modulation (PCM) signal is encoded by an appropriate encoding tool corresponding to a property of the input audio signal. For example, when an input audio signal is a stereo signal, which includes an L-channel signal and an R-channel signal which contain similar frequency components, a tool, such as “intensity stereo” or “mid/side stereo coding (M/S),” is used.

When an input signal has large temporal fluctuations, a tool, such as “block switching” or “temporal noise shaping (TNS),” is used. In the AAC scheme, a time-domain signal is converted into a frequency-domain signal (frequency signal) (frequency conversion), which is then encoded (frequency domain coding scheme). When an input signal has large temporal fluctuations, the tool “block switching” converts the input signal into a frequency-domain signal at shorter time intervals, thereby increasing the temporal resolution. When an input signal has large temporal fluctuations, conversion to a frequency-domain signal is frequently performed by the tool “block switching.” The tool “TNS” is a predictive encoder for a frequency signal. When an input signal has large temporal fluctuations, the frequency signal is flat, and therefore, the compression ratio is more frequently increased by using the predictive encoder.

Because speech contains consonants and vowels which are repeatedly articulated for a considerably short time, there are large temporally fluctuations in speech. Therefore, an AAC encoder frequently uses “block switching” and “TNS” for speech signals.

The audio bit stream analyzer 122 analyzes whether or not the audio bit stream ABS contains human voice. In this case, for example, the audio bit stream analyzer 122 analyzes the frequency at which an audio signal to be encoded has been predictively encoded and the frequency at which an audio signal to be encoded has been converted into a frequency-domain signal, in each section having a predetermined length of the audio bit stream ABS. The frequency of predictive encoding is obtained based on, for example, a flag contained in the audio bit stream ABS which indicates that “TNS” has been performed. The frequency of conversion to a frequency-domain signal is obtained based on, for example, a flag contained in the audio bit stream ABS which indicates that “block switching” has been performed. The audio bit stream analyzer 122 outputs the obtained frequencies as analysis results to the playback speed determiner 124.

The audio decoder 112 decodes the input audio bit stream ABS, and outputs the resulting audio signal (PCM signal) to the variable speed reproducer 114. The details of decoding of a bit stream encoded using the AAC scheme are described in the MPEG standards, and the description thereof will not be given.

Next, the playback speed determiner 124 determines a playback speed based on the analysis results of the audio bit stream analyzer 122. In this case, for example, the playback speed determiner 124 determines a playback speed in each section based on the frequency at which an audio signal has been predictively encoded and the frequency at which an audio signal has been converted into a frequency-domain signal.

If “block switching” and “TNS” are used at a frequency higher than a predetermined threshold in a section, the playback speed determiner 124 determines that a large amount of speech signals is contained in the section, and determines a playback speed so that playback is performed at a relatively slow speed (e.g., 1.3× speed, etc.) even during fast playback (e.g., a target average playback speed (also simply referred to as a target playback speed) is 2× speed). Otherwise, the playback speed determiner 124 determines that a speech signal is not contained in the section, and determines a playback speed so that playback is performed at a speed (e.g., 3× or 4× speed if the target playback speed is 2×) higher than the target playback speed.

In order to more correctly determine whether or not speech is contained, analysis of the decoded PCM signal may be performed in combination. For example, a conventional analysis technique may be used to determine whether or not speech is contained in the decoded PCM signal, and the criterion may be determined based on the analysis results of the audio bit stream analyzer 122. In this case, the result of the determination is more correct.

The variable speed reproducer 114 receives the audio signal output from the audio decoder 112 to reproduce an audio signal ASR corresponding to a playback speed determined by the playback speed determiner 124. The playback speed may be changed by any conventional technique, such as shortening of a signal along the time axis, cross-fading, etc.

Thus, in the digital signal reproduction device of FIG. 1, it is determined whether or not speech is contained in an audio bit stream before decoding, whereby the amount of computation required to determine whether or not speech is contained can be reduced.

Note that the playback speed determiner 124 may determine a playback speed based on only one of the frequency of “block switching” or the frequency of “TNS.”

Although it has been assumed that the input audio bit stream is a stream encoded using the AAC scheme, the present disclosure is not limited to this. For example, a stream encoded using an encoding scheme called “speech/audio integrated codec,” which the MPEG Audio standards organization has been studying and standardizing in recent years, is also suitable as the input bit stream. In the “speech/audio integrated codec,” speech signals (human voice) and the other audio signals (musical sound, natural sound) are encoded using respective suitable encoding techniques, which are automatically selected. An encoded bit stream obtained as a result of encoding should contain information explicitly indicating what encoding scheme has been used. In this case, by extracting such information from a bit stream, the determination of whether or not speech is contained can be significantly facilitated.

Although, in FIG. 1, attention has been paid to the function of controlling the playback speed when a digital signal is reproduced, the configuration of FIG. 1 may have other functions. For example, the playback speed determiner 124 may determine equalizing characteristics or spatial acoustic characteristics based on the analysis results of the audio bit stream analyzer 122. The variable speed reproducer 114 may have a function of achieving the determined equalizing characteristics or spatial acoustic characteristics. For example, the variable speed reproducer 114 may use a filter for increasing the clarity of a speech band (a pitch frequency band or a formant frequency band) if an input signal is of speech, or a filter for extending spatial acoustic characteristics if an input signal is of multi-channel musical sound.

FIG. 2 is a block diagram showing an example configuration of a digital signal compression device according to the first embodiment of the present disclosure. The digital signal compression device 200 of FIG. 2 includes an audio signal classifier 254, a first controller 262, a predictive encoder 264, a frequency conversion encoder 266, and a second controller 272. The first controller 262, the predictive encoder 264, and the frequency conversion encoder 266 form an audio encoder 260.

Initially, the audio signal classifier 254 analyzes each section having a predetermined length of an input audio signal ASG to determine an index R indicating how much speech (human voice) components are contained in the audio signal, and outputs the index R to the first controller 262. This may be performed using any conventional technique. For example, this may be performed based on the intensity of a signal in the formant frequency band (the upper end of which is about 3 kHz or lower) of speech, temporal fluctuations in the signal intensity, or whether or not a signal having a predetermined intensity or more is present in the pitch frequency band of speech.

The first controller 262 determines which of the encoders (264 and 266) is used to encode the audio signal ASG, based on the index R output from the audio signal classifier 254. Specifically, if the index R is larger than a predetermined threshold (a large amount of human voice components is contained), the first controller 262 determines that the predictive encoder 264 is used to encode a section corresponding to the index R of the audio signal ASG. When the index R is smaller than or equal to the predetermined threshold (the amount of human voice components contained is not very large), the first controller 262 determines that the frequency conversion encoder 266 is used to encode the section corresponding to the index R of the audio signal ASG. The first controller 262 outputs the audio signal ASG to the determined encoder (264 or 266).

The predictive encoder 264 predictively encodes the audio signal output from the first controller 262, and outputs the resulting encoded data to the second controller 272. In the linear prediction coding scheme, speech (human voice) is separated into sound source components and prediction coefficients (acoustic characteristic coefficients), which are then separately compressed (encoded). Here, the linear prediction coding scheme may be an encoding scheme for speech, such as G.729 etc. defined in the international telecommunication union-telecommunication sector (ITU-T), or AMR-NB, AMR-WB, etc. defined in the third generation partnership project (3GPP).

The frequency conversion encoder 266 encodes the audio signal output from the first controller 262 using the frequency domain coding scheme, and outputs the resulting encoded data to the second controller 272. In the frequency domain coding scheme, an input audio signal is converted into a frequency-domain signal by modified discrete cosine transform (MDCT), quadrature mirror filters (QMF), etc., and the frequency-domain signal is compressed (encoded), where each frequency component thereof is weighted. Here, the frequency domain coding scheme is, for example, an encoding scheme for audio defined in AAC or high-efficiency advanced audio coding (HE-AAC).

The second controller 272 generates the audio bit stream ABS from the encoded data generated by the predictive encoder 264 or the frequency conversion encoder 266, and outputs the audio bit stream ABS.

In the digital signal compression device 200 of FIG. 2, when a bit stream is generated (encoded), it is analyzed how much speech components are contained in each section having a predetermined length of an audio signal, and based on the result, an encoding scheme is determined. Therefore, the quality of encoding can be improved. Moreover, during a playback of the generated encoded data, it can be easily determined whether or not speech is contained for each section, by only analyzing the frequency at which the linear prediction coding scheme is used.

In the digital signal compression device 200 of FIG. 2, the entire band of the input audio signal ASG is encoded by one of the linear prediction coding scheme or the frequency domain coding scheme. However, the present disclosure is not necessarily limited to this. For example, in view of the fact that main frequency components of a speech signal are concentrated in a low frequency band, the switching of encoding schemes depending on whether or not speech is contained may be limited to low frequency components. In this case, for example, high frequency components may be encoded by spectral band replication (SBR), which is a band extension technique defined in the AAC+SBR scheme (ISO/IEC14496-3) of the MPEG standards.

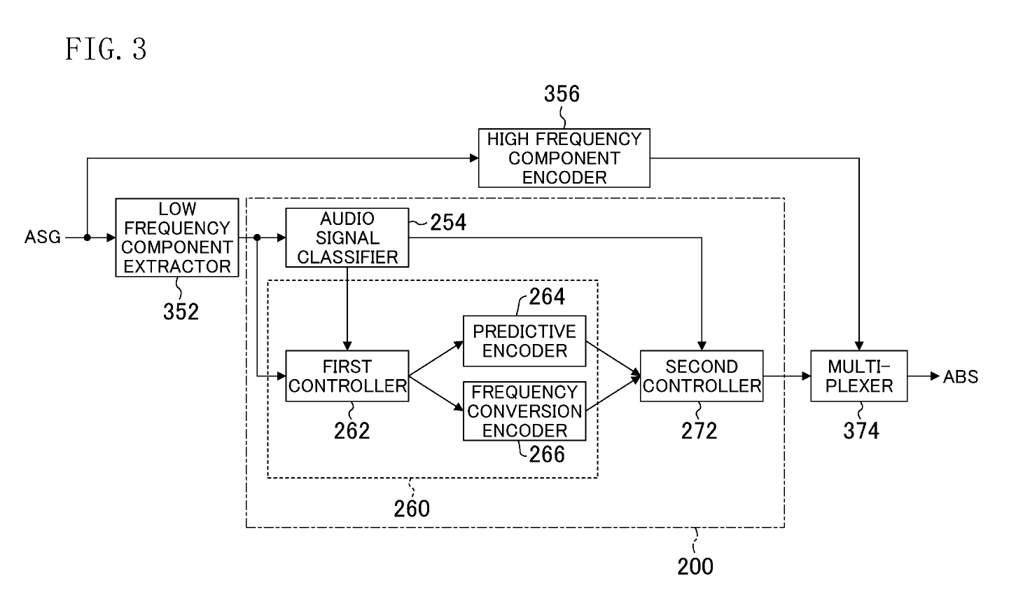

FIG. 3 is a block diagram showing a configuration of a first variation of the digital signal compression device 200 of FIG. 2. The digital signal compression device of FIG. 3 includes the digital signal compression device 200 of FIG. 2, a low frequency component extractor 352, a high frequency component encoder 356, and a multiplexer 374.

Initially, the low frequency component extractor 352 extracts a low frequency band signal from the input audio signal ASG, and outputs the low frequency band signal to an audio signal classifier 354 and a first controller 362. The extraction may be performed using a low-pass filter, or by converting, into a time-domain signal, a low frequency component of a signal converted into a frequency-domain signal. The high frequency component encoder 356 encodes a high frequency component of the input audio signal ASG using a band extension technique, and outputs the resulting encoded data. The band extension technique may be, for example, SBR defined in the AAC+SBR scheme (ISO/IEC14496-3) of the MPEG standards.

The digital signal compression device 200 is similar to that of FIG. 2, except that an output signal of the low frequency component extractor 352 is input, and therefore, the description thereof will not be given. The multiplexer 374 multiplexes an audio bit stream output from a second controller 372 with encoded data output from the high frequency component encoder 356 to generate the audio bit stream ABS, and outputs the audio bit stream ABS.

Thus, because main frequency components of human voice are concentrated in a low frequency region, the digital signal compression device of FIG. 3 encodes only a low frequency component(s) of the input audio signal ASG using a linear prediction coding scheme. Therefore, compared to the digital signal compression device of FIG. 2, the quality of encoding can be further improved. Moreover, during a playback of the encoded data, it can be easily determined whether or not speech is contained in each section, by only analyzing low frequency region data of a bit stream.

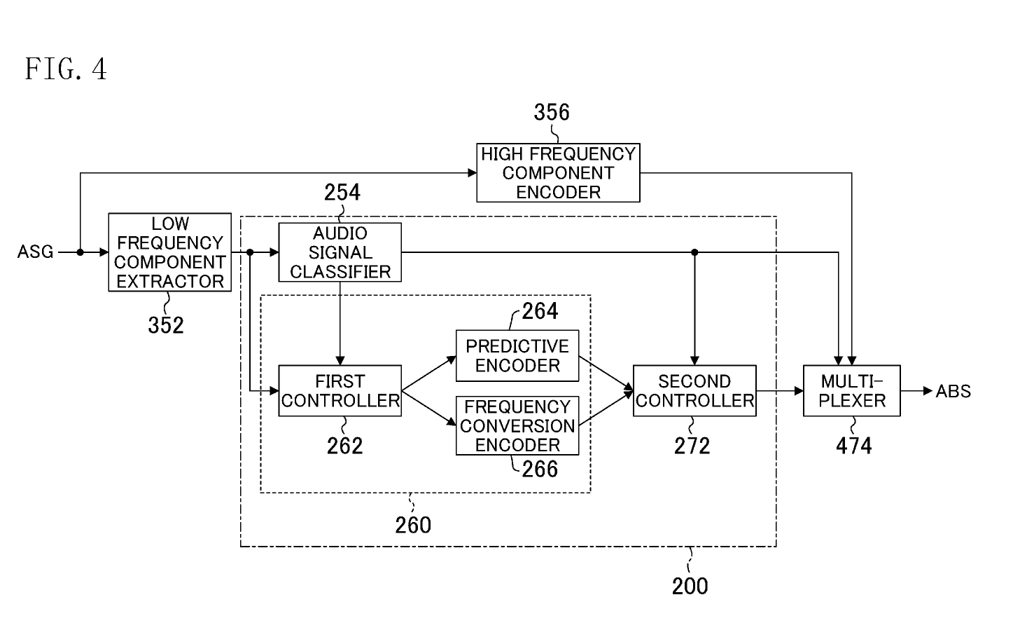

FIG. 4 is a block diagram showing a configuration of a second variation of the digital signal compression device 200 of FIG. 2. The digital signal compression device of FIG. 4 is different from that of FIG. 3 in that a multiplexer 474 is provided instead of the multiplexer 374. The multiplexer 474 multiplexes an index R determined by the audio signal classifier 254 or the encoded index R, with an audio bit stream output from the second controller 272 and an encoded data output from the high frequency component encoder 356, and outputs the result as the audio bit stream ABS.

As a result, during a playback of a bit stream, it can be more correctly determined how much speech components are contained in each section. The input audio signal ASG may not be necessarily simply divided into sections which contain speech and sections which do not contain speech. Therefore, if the reproduction device can know the index R based on which the determination has been performed, the quality of reproduction can be further improved. For example, if the index R has a considerably large value, it is determined that the audio signal ASG contains substantially only speech components, and therefore, a reproduction process suitable for speech (e.g., emphasis of speech-band components, etc.) may be performed. Conversely, if the index R has a considerably small value, it is determined that the audio signal ASG does not contain speech, and therefore, a reproduction process suitable for audio (e.g., production of rich sound by emphasizing deep bass or a high-frequency signal, etc.) may be performed. If the index R has an intermediate value, both of the processes may be performed when necessary.

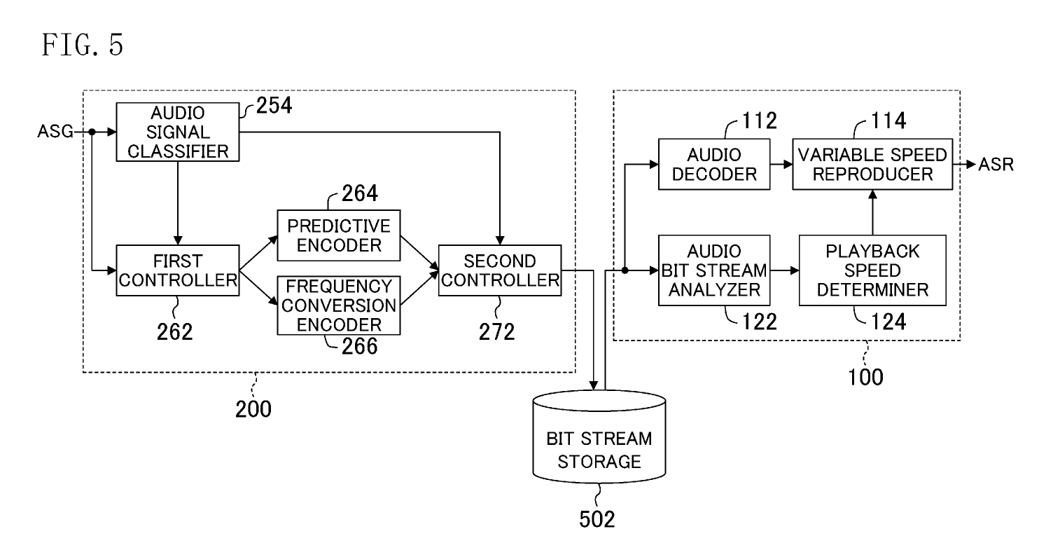

FIG. 5 is a block diagram showing an example recorder system including the digital signal reproduction device of FIG. 1 and the digital signal compression device of FIG. 2. The recorder system of FIG. 5 includes the digital signal reproduction device 100 of FIG. 1, the digital signal compression device 200 of FIG. 2, and a bit stream storage 502. The bit stream storage 502 may be any storage medium that can store data, such as a DVD, a BD, a compact disc (CD), an HDD, a memory card, etc. Also, the bit stream storage 502 and the digital signal reproduction device 100 of FIG. 1 may be integrated together.

### Second Embodiment

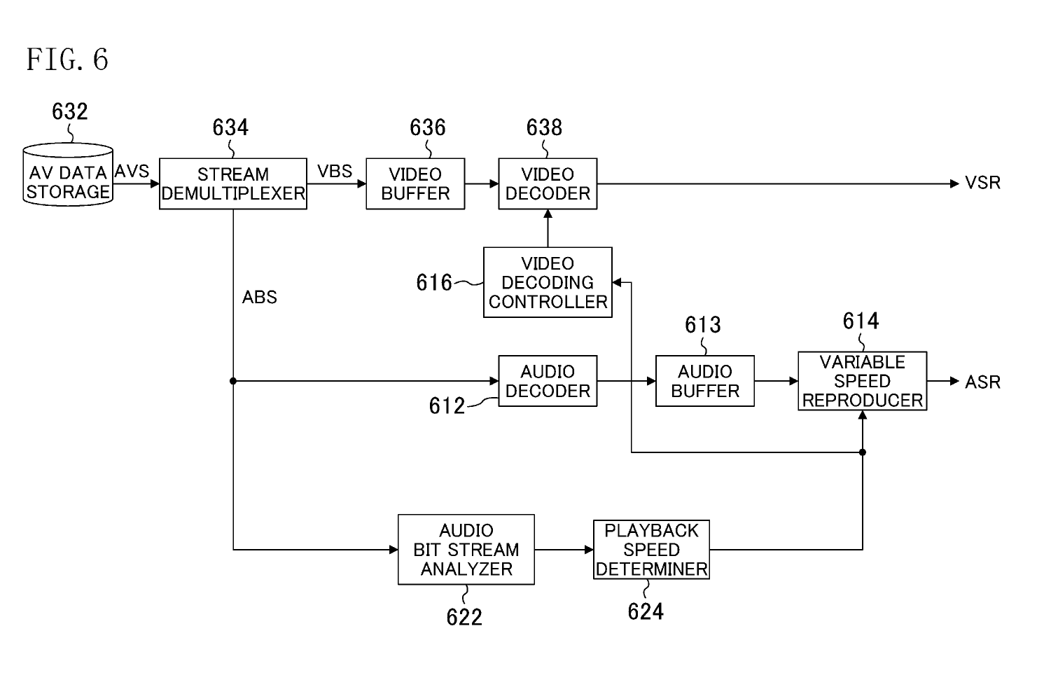

FIG. 6 is a block diagram showing an example configuration of a digital signal reproduction device according to a second embodiment of the present disclosure. The digital signal reproduction device of FIG. 6 includes an audio decoder 612, an audio buffer 613, a variable speed reproducer 614, a video decoding controller 616, an audio bit stream analyzer 622, a playback speed determiner 624, an audio/visual (AV) data storage 632, a stream demultiplexer 634, a video buffer 636, and a video decoder 638.

The AV data storage 632 stores a bit stream in which a video bit stream and an audio bit stream are multiplexed. The AV data storage 632 outputs the bit stream as an AV bit stream AVS to the stream demultiplexer 634. The stream demultiplexer 634 separates the AV bit stream AVS into a video bit stream VBS and an audio bit stream ABS, and outputs the video bit stream VBS to the video buffer 636 and the audio bit stream ABS to the audio decoder 612 and the audio bit stream analyzer 622.

The audio decoder 612, the variable speed reproducer 614, the audio bit stream analyzer 622, and the playback speed determiner 624 are similar to the corresponding ones of FIG. 1, and therefore, the description thereof will not be given. The audio buffer 613 stores an audio signal output from the audio decoder 612, and outputs the audio signal to the variable speed reproducer 614.

The video buffer 636 stores the video bit stream VBS and outputs the video bit stream VBS to the video decoder 638. The video decoding controller 616 determines a decoding process of the video bit stream VBS so that video is reproduced at a speed corresponding to a playback speed determined by the playback speed determiner 624. The video decoder 638 decodes a video bit stream output from the video buffer 636 based on the result of the determination by the video decoding controller 616, and outputs the resulting video signal VSR.

Operation of the digital signal reproduction device thus configured of FIG. 6 will be described in detail hereinafter. It is assumed that the AV data storage 632 stores a bit stream in which a video bit stream conforming to MPEG-2 video (ISO/IEC13818-2) and an audio bit stream conforming to MPEG-2 AAC (ISO/IEC13818-7) are multiplexed in the MPEG-2 transport stream (TS) format (ISO/IEC13818-1).

MPEG-2 video is a moving image compression scheme which uses inter-frame prediction. In this scheme, pictures included in a video signal are divided into three types, I-pictures, P-pictures, and B-pictures, depending on the prediction technique. An I-picture is a picture from which reproduction of a moving image is started, and can be reproduced independently. A P-picture cannot be reproduced without an I-picture and a P-picture preceding in time, and has a smaller amount of data to be encoded than that of an I-picture. A B-picture cannot be reproduced without I-pictures and P-pictures preceding and following in time, and has a smaller amount of data to be encoded than those of an I-picture and a P-picture.

For example, in digital broadcasts, I-, P-, and B-pictures are typically combined and displayed in the order of IBBPBBPBBPBBPBB, taking into consideration the balance between the image quality and the amount of data to be encoded, where I represents an I I-picture, P represents a P-picture, and B represents a B-picture. In order to enable reproduction of video to start from a midpoint of a bit stream, an I-picture typically appears at intervals of about 0.5 sec. In digital broadcasts, typically, 30 frames are transmitted per sec, and one frame contains one picture. In this case, 15 pictures are transmitted for 0.5 sec, and pictures are typically arranged as repetitions of IBBPBBPBBPBBPBB (IPBB . . . ).

MPEG-2 TS is a bit stream in which a video bit stream and an audio bit stream which are typically used in digital broadcasts etc. are multiplexed. In this stream, packets obtained by dividing a video bit stream and an audio bit stream into segments having a fixed length are alternately arranged in time. In general, the amount of data to be encoded of a video bit stream is larger than that of an audio bit stream. Therefore, for example, a bit stream of MPEG-2 TS contains video packets (represented by V) and audio packets (represented by A), which are arranged in the order of AVVVVVVAVVVVVV.

Initially, the stream demultiplexer 634 extracts video packets (V) from a bit stream having the MPEG-2 TS format input from the AV data storage 632, joins the extracted packets together, and outputs the resulting packets to the video buffer 636. The stream demultiplexer 634 also extracts audio packets (A), joins the extracted packets together, and outputs the resulting packets to the audio bit stream analyzer 622 and the audio decoder 612.

Here, for example, it is assumed that the playback speed determiner 624 determines that the playback speed is 3×. In this case, in order to reproduce audio and video in synchronization with each other, not only audio but also video need to be reproduced at 3× speed. However, in digital broadcasts, it is necessary to deal with a large amount of video data (e.g., high-definition (HD) video (one frame including 1920×1080 pixels)). Therefore, a simple calculation shows that if decoding and reproduction are performed at 3× speed, the amount of computation is also triple, which is not practical. As described above, digital broadcasts typically have a picture arrangement, such as IBBPBBPBBPBBPBB. Therefore, for example, if decoding of B-pictures is skipped, and only I-pictures and P-pictures are decoded to reproduce images, only 5 of 15 pictures are decoded. Therefore, the playback speed can be tripled.

Thus, the video decoding controller 616 determines which of the pictures is to be skipped and which of the pictures is to be reproduced, based on the playback speed determined by the playback speed determiner 624, and notifies the video decoder 638 of these pictures. The video decoder 638 decodes a video bit stream based on the results of the determination by the video decoding controller 616, and outputs the resulting video signal.

However, a buffer is required in order to output a video signal and a speech signal perfectly synchronously with each other. As described above, the video picture arrangement has the order of IBBPBBPBBPBBPBBPBB, but this is not the order of encoding. A B-picture is used to predict a P-picture following in time, and therefore, the order of encoding is IPBBPBBPBBPBBPBB. That is, a P-picture precedes a B-picture. Thus, in a bit stream, pictures are arranged in the order which is different from that in which the pictures are actually reproduced. Therefore, in the MPEG-2 TS format, although audio packets and video packets are multiplexed equally in time, multiplexed video precedes multiplexed audio in time if attention is paid to a specific picture.

There is a delay time between when an audio bit stream is separated by the stream demultiplexer 634 and when a playback speed is determined by the playback speed determiner 624. In other words, stream separation and video decoding precede the determination of the playback speed.

For the above two reasons, if a video bit stream separated by the stream demultiplexer 634 is immediately decoded by the video decoder 638, video decoding corresponding to audio is already completed before the playback speed determiner 624 determines a playback speed. Therefore, a picture cannot be skipped in the intended manner.

Therefore, as shown in FIG. 6, the video buffer 636 is provided between the stream demultiplexer 634 and the video decoder 638 to store a video bit stream. After a video bit stream is stored in the video buffer 636 and the playback speed determiner 624 determines a playback speed, the video decoder 638 is caused to be ready to start the process. In this case, the video buffer 636 needs to have at least a capacity corresponding to a bit stream corresponding to a number of preceding encoded P-pictures (in this example, two P-pictures preceding in time have been encoded) and the delay time until a playback speed is determined.

In the MPEG-2 TS format, a video bit stream and an audio bit stream are multiplexed with appropriate timing so that a video signal and a speech signal can be output synchronously with each other. In the configuration of FIG. 6, if only the video signal is delayed by the video buffer 636, the speech signal may precede the video signal, so that the speech signal and the video signal may not be output synchronously with each other. Therefore, the audio buffer 613 may be provided in a stage following the audio decoder 612, whereby the output of the speech signal can be delayed, so that the video signal and the speech signal are output synchronously with each other.

While, in the configuration of FIG. 6, the audio buffer 613 is provided in a stage following the audio decoder 612, the audio buffer 613 may be provided in a stage preceding the audio decoder 612 or in a stage following the variable speed reproducer 614. In other words, the speech signal may be delayed based on the video signal.

In the configuration of FIG. 6, the playback speed determiner 624 determines a playback speed based on the result of analysis of a bit stream by the audio bit stream analyzer 622. The method of determining a playback speed is not limited to this. For example, speech data may be analyzed based on the decoding result of the audio decoder 612 to detect a speech section, and based on the detection result, a playback speed may be determined.

In FIG. 6, the video buffer 636 and the audio buffer 613 are required. The required sizes of the two buffers depend on how much video decoding needs to be delayed. In the above picture arrangement, video decoding needs to be delayed by 2-3 frames or more. The playback speed is not immediately determined, but is inherently determined based on a relationship between sections preceding and following speech, such as the ratio of speech sections or non-speech sections, etc. Therefore, a delay time occurs until the determination of a playback speed. In this case, if the delay time is set to be large, the playback speed can be more appropriately determined. For example, the playback speed may be adjusted based on the duration of a speech section. Also, for example, even if a non-speech section temporarily occurs, but a speech section follows immediately after the non-speech section, the playback speed during the non-speech section may be set to be the same as that during the speech section.

It is assumed that a delay time caused by the picture arrangement, a delay time until the determination of a playback speed, etc. are each about one second. In this case, the required size of the video buffer 636 is, for example, about 20 Mbits in the case of digital broadcasts. The required size of the audio buffer 613 is, for example, about 3.92 Mbits (=48 kHz×16 bits×5.1 channels) when the audio buffer 613 is provided in a stage following the audio decoder 612. If the accuracy of the playback speed is increased, a delay of several seconds is required instead of one second, the increase in the capacities of the video buffer 636 and the audio buffer 613 may not be acceptable in terms of cost. Therefore, these buffers may not be used.

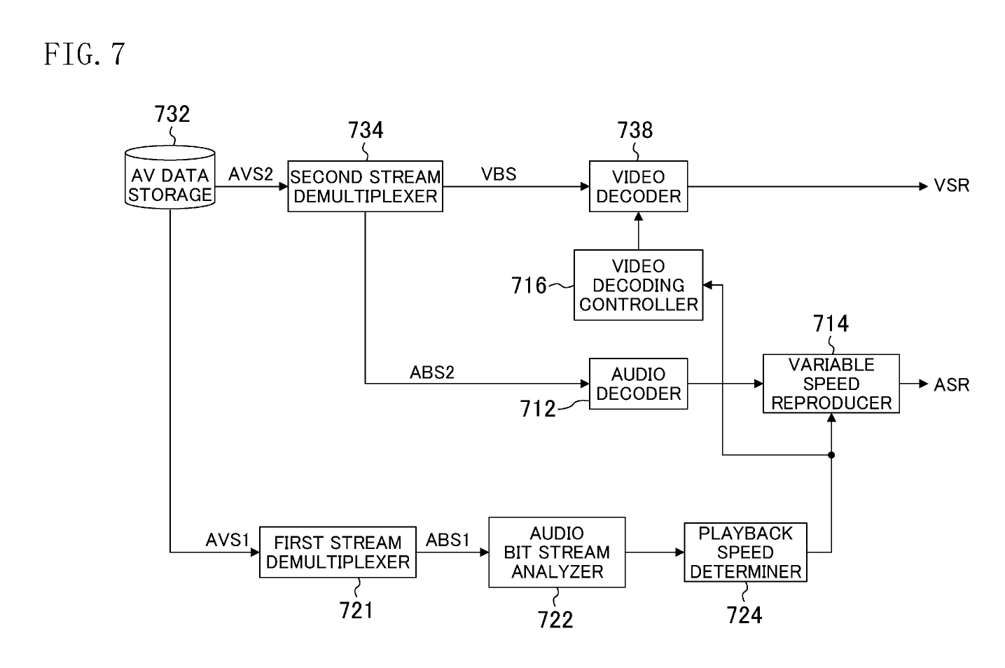

FIG. 7 is a block diagram showing a configuration of a variation of the digital signal reproduction device of FIG. 6. The digital signal reproduction device of FIG. 7 includes an audio decoder 712, a variable speed reproducer 714, a video decoding controller 716, a first stream demultiplexer 721, an audio bit stream analyzer 722, a playback speed determiner 724, an AV data storage 732, a second stream demultiplexer 734, and a video decoder 738.

The first stream demultiplexer 721 separates an audio bit stream from a multiplexed AV bit stream AVS1, and outputs the audio bit stream. The audio bit stream analyzer 722 analyzes whether or not the audio bit stream ABS1 separated by the first stream demultiplexer 721 contains human voice. The second stream demultiplexer 734 separates an AV bit stream AVS2 obtained by delaying the AV bit stream AVS1 into an audio bit stream and a video bit stream, and outputs the audio bit stream and the video bit stream. The audio decoder 712 decodes the audio bit stream ABS2 separated by the second stream demultiplexer 734.

Operation of the digital signal reproduction device of FIG. 7 will be described in detail hereinafter. Initially, the first stream demultiplexer 721 extracts audio packets from the bit stream AVS1 having the MPEG-2 TS format stored in the AV data storage 732, joins the extracted packets together, and outputs the resulting packets as the audio bit stream ABS1 to the audio bit stream analyzer 722. The first stream demultiplexer 721 abandons video packets.

The audio decoder 712, the variable speed reproducer 714, the audio bit stream analyzer 722, and the playback speed determiner 724 are similar to the corresponding ones of FIG. 1, and the video decoding controller 716 and the video decoder 738 are similar to the corresponding ones of FIG. 6, and therefore, the description thereof will not be given.

Next, the second stream demultiplexer 734 reads, as the bit stream AVS2, the bit stream AVS1 having the MPEG-2 TS format stored in the AV data storage 732, which is the same as that described above, again after a predetermined period of time has elapsed, and next, extracts video packets, joins the extracted packets together, and outputs the resulting packets as the video bit stream VBS to the video decoder 738. The second stream demultiplexer 734 also similarly extracts audio packets, joins the extracted packets together, and outputs the resulting packets as the audio bit stream ABS2 to the audio decoder 712.

The digital signal reproduction device of FIG. 7 is different from that of FIG. 6 in that the playback speed determiner 724 determines a playback speed before video decoding, and therefore, a video buffer is not required. Also, a delay does not occur in a video signal, and therefore, an audio buffer is not required.

The first stream demultiplexer 721 and the second stream demultiplexer 734 operate in parallel with respect to the same AV bit stream. Initially, the first stream demultiplexer 721 starts processing the bit stream AVS1 before the second stream demultiplexer 734 starts processing the bit stream AVS2 obtained by delaying the bit stream AVS1.

Note that, in the device of FIG. 7, a period of time by which the operation of the first stream demultiplexer 721 precedes the operation of the second stream demultiplexer 734 is the sum of two frames or more because of the nature of frame prediction in video encoding and the process delay time of the playback speed determiner 724 (depending on the accuracy of a playback speed), similar to the video buffer in the device of FIG. 6. If the time period of the preceding operation is excessively short, a problem with timing of reproduction of video or speech arises (e.g., the playback speed is not yet determined, etc.). Therefore, the time period of the preceding operation needs to be carefully determined. Unlike the case of FIG. 6, if the time period of the preceding operation is excessively long, the buffer size is not affected, but it should be noted that a buffer for storing information about the playback speed determined by the playback speed determiner 724 is required. Moreover, it should be noted that a delay time increases between when the playback speed is changed and when the change is actually reflected on the output of a video signal or a speech signal. It is necessary to set the time period of the preceding operation to an appropriate time in view of the above points.

In the configuration of FIG. 7, the playback speed determiner 724 determines a playback speed based on the result of analysis of a bit stream by the audio bit stream analyzer 722. The method of determining a playback speed is not limited to this. For example, an audio bit stream output from the first stream demultiplexer 721 may be decoded, the resulting speech data may be analyzed to detect a speech section, and based on the result of detection of a speech section, a playback speed may be determined.

In the configuration of FIG. 7, the first stream demultiplexer 721 and the second stream demultiplexer 734 are assumed to operation simultaneously. Alternatively, a single stream demultiplexer may operate as two stream demultiplexers in a time-division manner.

While, in the digital signal reproduction devices of FIGS. 6 and 7, an example has been described in which the playback speed is 3×, the playback speed may have other values. As described above, in digital broadcasts, the pictures are typically arranged as repetitions of IBBPBBPBBPBBPBB (IBBP . . . ). Therefore, a technique of achieving a playback speed other than 3× will be described using the repeating unit of 15 pictures.

In MPEG-2 video, if decoding of an I-picture is skipped, P- and B-pictures for which the I-picture is required for prediction cannot be decoded. If decoding of a P-picture is skipped, P- and B-pictures following that P-picture for which that P-picture is required for prediction cannot be decoded. Even if decoding of a B-picture is skipped, decoding of the other pictures is not affected. These properties can be utilized. For example, as described below, if decoding of four B-pictures is skipped, 1.5× speed is obtained. If decoding of all (eight) B-pictures is skipped, 3× speed is obtained. If decoding of all (eight) B-pictures and all (four) P-pictures is skipped, 15× speed is obtained. These cases are represented by the following sequences of letters representing the pictures.

| | | | | | | | | | | | | | | | | |
|---|---|---|---|---|---|---|---|---|---|---|---|---|---|---|---|---|
| I | B | B | P | B | B | P | B | B | P | B | B | P | B | B | I | 1x |
| I | B | | P | B | | P | B | | P | B | | P | B | | I | 1.5x |
| I | | | P | | | P | | | P | | | P | | | I | 3x |
| I | | | | | | | | | | | | | | | I | 15x |

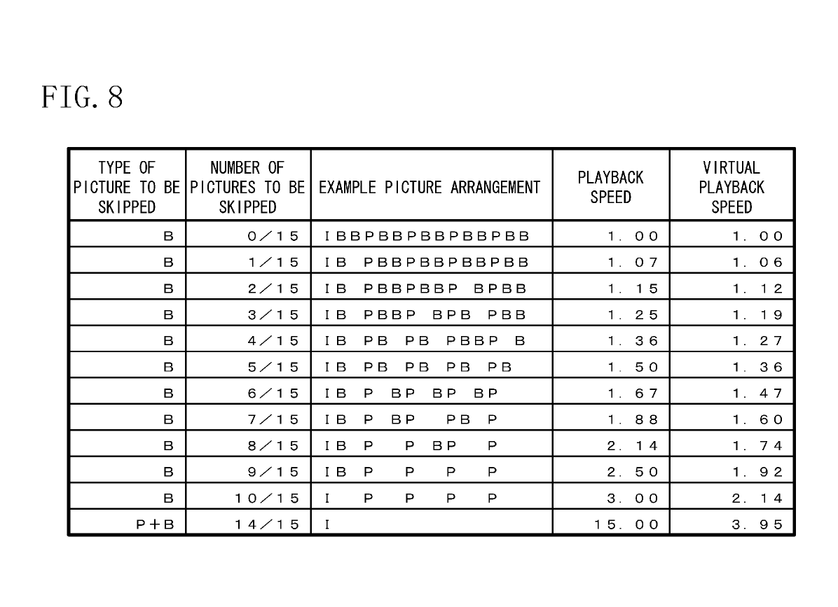

If pictures to be skipped are more finely controlled, the playback speed can be changed to other values. FIG. 8 is a diagram showing typical example combinations of the type(s) and number of pictures to be skipped and a playback speed. In the example of FIG. 8, 12 playback speeds are obtained. While, in this embodiment, picture skipping is controlled in units of 15 frames, a larger number of different playback speeds can be obtained by controlling picture skipping in other units (e.g., 6 frames, 30 frames, etc.). The video decoding controllers 616 or 716 determines the number of frames contained in the picture skipping control unit and the type(s) and number of pictures to be skipped so that video is reproduced at a speed corresponding to the playback speed determined by the playback speed determiner 624 or 724.

Note that a pattern of pictures to be decoded is determined so that an unnatural moving image is not produced. By using such a picture pattern which reduces or avoids an unnatural moving image, and further, thinning or repeating frames, the video playback speed is caused to match the audio playback speed.

In this embodiment, the playback speed is determined, assuming that the time required to skip a picture is zero. Actually, when a picture is skipped, it takes a time to read the bit stream to find the head of the next picture. Although it is considered that the time required to skip a bit stream corresponding to one picture is sufficiently smaller than the decoding time, a non-negligible delay time occurs if a large number of pictures are skipped. The time required to skip a picture depends on the size of a bit stream to be skipped. In the MPEG-2 video, pictures do not have a fixed size, and therefore, the maximum size needs to be taken into consideration. Here, a playback speed which is recalculated on the assumption that the time required to skip a picture is ⅕ of the decoding time, is shown as a virtual playback speed in FIG. 8.

In this embodiment, pictures are arranged in the order of IBBPBBPBBPBBPBB. Any picture arrangement which enables skipping of decoding of at least one picture may be used to achieve similar reproduction.

In this embodiment, it has been assumed that video decoding can be invariably achieved at a playback speed determined by the playback speed determiner 624 or 724. However, a video signal may fail to be reproduced at a playback speed determined by the playback speed determiner 624 or 724 in the following cases: the number of pictures which can be skipped is smaller than what is assumed (e.g., the picture arrangement may be suddenly changed to IPPPPPPPPPPPPPP); and the time required to skip a picture is longer than what is assumed (in this embodiment, the time required to skip a picture is assumed to be ⅕ of the decoding time, but may exceed it). In this case, decoding of a video signal has not been completed at the time when a speech signal is output, and therefore, the same video signal continues to be output. In order to quickly recover from such a situation, if reproduction cannot be performed at a specified playback speed, a signal for slowing the current playback speed may be fed from the video decoding controller 638 or 738 back to the playback speed determiner 624 or 724 so that the video signal can be subsequently reproduced at the specified playback speed.

In this embodiment, MPEG-2 video is used as an encoding scheme for video signals. Other moving image encoding schemes, such as H.264 etc., may be similarly used if decoding of a picture can be skipped.

In this embodiment, MPEG-2 AAC is used as an encoding scheme for speech signals. Any other speech encoding schemes may be similarly used.

In this embodiment, MPEG-2 TS is used as a multiplexing scheme for video and speech signals. In the configuration of FIG. 6, any multiplexing schemes that combine and multiplex a video bit stream and an audio bit stream which are to be output at the same time may be similarly used. In the configuration of FIG. 9, any other multiplexing schemes, such as a multiplexing scheme which multiplexes video bit streams and audio bit streams separately (e.g., MPEG-2 PS (ISO/IEC13818-1) etc.) etc., may be similarly used.

The many features and advantages of the present disclosure are apparent from the written description, and thus, it is intended by the appended claims to cover all such features and advantages of the present disclosure. Further, since numerous modifications and changes will readily occur to those skilled in the art, it is not desired to limit the present disclosure to the exact configurations and operations as illustrated and described. Hence, all suitable modifications and equivalents may be contemplated as falling within the scope of the present disclosure.

As described above, according to the embodiments of the present disclosure, only a small amount of computation is required to determine whether or not human voice is contained, and the determination is facilitated. Therefore, the present disclosure is useful for digital signal reproduction devices, digital signal compression devices, etc. The present disclosure is also useful for players and recorders for a BD, a DVD, an HDD, a memory card, etc.

What is claimed is:

1. A digital signal reproduction device comprising:
an audio decoder configured to decode an audio bit stream to output a resulting audio signal;
an audio bit stream analyzer configured to analyze whether or not the audio bit stream contains human voice;
a playback speed determiner configured to determine a playback speed based on a result of the analysis by the audio bit stream analyzer; and
a variable speed reproducer configured to receive the audio signal and reproduce an audio signal corresponding to the playback speed determined by the playback speed determiner.

2. The digital signal reproduction device of claim 1, wherein
the audio bit stream analyzer analyzes a frequency of predictive encoding in each section having a predetermined length of the audio bit stream, and
the playback speed determiner determines a playback speed for each section based on the frequency of predictive encoding in the section.

3. The digital signal reproduction device of claim 1, wherein
the audio bit stream analyzer analyzes a frequency of conversion to a frequency-domain signal in each section having a predetermined length of the audio bit stream, and
the playback speed determiner determines a playback speed for each section based on the frequency of the conversion in the section.

4. The digital signal reproduction device of claim 1, further comprising:
a video decoding controller configured to determine a decoding process of a video bit stream so that video is reproduced at a speed corresponding to the playback speed determined by the playback speed determiner; and
a video decoder configured to decode the video bit stream based on a result of the determination by the video decoding controller.

5. The digital signal reproduction device of claim 4, further comprising:
a stream demultiplexer configured to separate a multiplexed bit stream into the audio bit stream and the video bit stream;
a first buffer configured to store the video bit stream separated by the stream demultiplexer and output the video bit stream to the video decoder; and
a second buffer configured to store the audio signal output from the audio decoder and output the audio signal to the variable speed reproducer.

6. The digital signal reproduction device of claim 4, wherein
a stream demultiplexer configured to separate a multiplexed bit stream into the audio bit stream and the video bit stream;
a first buffer configured to store the video bit stream separated by the stream demultiplexer and output the video bit stream to the video decoder; and
a second buffer configured to store the audio bit stream separated by the stream demultiplexer and output the audio bit stream to the audio decoder.

7. The digital signal reproduction device of claim 4, further comprising:
a first stream demultiplexer configured to separate a first audio bit stream from a multiplexed bit stream and output the first audio bit stream; and
a second stream demultiplexer configured to separate a bit stream obtained by delaying the multiplexed bit stream into a second audio bit stream and the video bit stream, wherein
the audio bit stream analyzer analyzes whether or not the first audio bit stream contains human voice, and
the audio decoder decodes the second audio bit stream.
